(19) United States
(12) Patent Application Publication
(10) Pub. No.: US 2011/0197817 A1
(43) Pub. Date: Aug. 18, 2011

(54) HABITAT FOR MOSQUITO GROWTH AND PROPAGATION

(76) Inventor: Nicholas Wren, Atlanta, GA (US)

(21) Appl. No.: 13/027,860

(22) Filed: Feb. 15, 2011

Related U.S. Application Data
(60) Provisional application No. 61/338,296, filed on Feb. 17, 2010.

(51) Int. Cl. A01K 29/00

(52) U.S. Cl. 119/6.5

(57) ABSTRACT

An embodiment of the present invention provides a habitat for the toxorhynchite mosquito. An embodiment of the habitat of the invention may be made in a multitude of shapes and sizes as one of ordinary skill in the art will recognize. As shown in the drawings and discussed below, the habitat may be constructed out of any number of materials and/or used objects, including used tires, cleaning bottles, or other similar objects, recycled materials, and/or by reusing products on hand in a particular locale.

### RELATED APPLICATIONS

This non-provisional utility patent application is related and claims the benefit and priority to U.S. Provisional Patent Application Ser. No. 61/338,296, filed Feb. 17, 2010, which is herein incorporated by reference.

### BACKGROUND OF THE INVENTION

1. Field of the Invention

This invention relates to the field of preventing the spread of malaria, dengue fever, and other mosquito-borne illnesses by providing a portable, sustainable, low-cost, and low-maintenance habitat for mosquitoes and other insects that prey on the larvae of human-feeding, disease-transmitting mosquitoes, such as the Toxorhynchite mosquito. More specifically, the invention described herein discloses a habitat designed to grow and sustain species such as the Toxorhynchite mosquito, by mimicking its natural environment and habitat.

2. Background

Each year, 300-500 million people are infected with malaria, resulting in death for one to three million cases. Malaria is widespread in tropical and sub-tropical regions, including the Americas, Asia, and Africa. Ninety percent of malaria-related deaths occur in sub-Saharan Africa.

Malaria is spread by the bites of anapholes mosquitoes. Specifically, when a mosquito bites an infected person, it takes in malarial parasites, which develop and grow inside the mosquito. Upon biting another person, the mosquito will transmit the malarial parasite to that person, where it develops in the liver and multiplies with the production of red blood cells. Therefore, the uncontrolled breeding and multiplication of the mosquito population is a direct cause of malaria. Anapholes mosquito larvae breed in standing, stagnant pools of water, such as rain pools, swamps, rice fields, grassy ditches, and the edges of rivers and streams. Therefore preventing mosquito bites controlling the mosquito population, especially in malaria-prone areas, is an effective way to control malaria.

Many types of mosquito control and prevention have been implemented in various locations around the world. Some examples of successful prevention and control measures include the use of mosquito netting, insect repellant, spraying insecticides, and draining free-standing water where mosquitoes lay their eggs. These methods of control and prevention, though, are problematic in many third-world countries where the necessary materials and chemicals are not available or are prohibitively expensive for the government or population to use or implement. It would be beneficial to have a solution to recycle or reuse products that are on-hand as trash or inexpensive and easy to mold and construct with no additional construction facilities necessary. It would further be beneficial to have a natural and environmentally friendly solution for controlling and preventing growth and multiplication of the mosquito population. It would further be beneficial for such a solution to be sufficiently portable and lightweight so that it could be placed wherever people are present, such as residences and near entryways and open windows of buildings.

The present invention discloses a habitat for the toxorhynchite mosquito, which does not feed on humans. Instead, the toxorhynchite genus of mosquito feeds on the larvae of other species of mosquitoes. The toxorhynchite genus of mosquito, though, may not have a natural habitat in areas where it is needed to help prevent the growth of malaria-spreading mosquitoes. It will be understood by one of ordinary skill in the art that although the specification discusses and discloses, specifically, the toxorhynchite genus of mosquito, specifically, the habitat may be used for any other insect or species that thrives in the natural habitat described herein and for any purpose. The description and disclosure, herein, relates to the multiple embodiments and features of the habitat, and only describes and exemplary use, nor for the purposes of limitation.

### SUMMARY OF THE INVENTION

An embodiment of the present invention provides a habitat for the toxorhynchite mosquito. An embodiment of the habitat of the invention may be made in a multitude of shapes and sizes as one of ordinary skill in the art will recognize. As shown in the drawings and discussed below, the habitat may be constructed out of any number of materials and/or used objects, including used tires, cleaning bottles, or other similar objects, recycled materials, and/or by reusing products on hand in a particular locale.

An embodiment of the invention is a habitat for mosquitoes and other insects comprising: an outer shell; at least one divider disposed such within the interior of the outer shell; and at least one upper opening in the upper half of said outer shell.

A further embodiment of the invention is a habitat wherein said outer shell is comprised of molded plastic.

A further embodiment of the invention is a habitat wherein said outer shell is comprised of a tire.

A further embodiment of the invention is a habitat wherein said outer shell is comprised of a monitor device.

A further embodiment of the invention is a habitat wherein said outer shell is further comprised of at least one opening in the rear of said outer shell.

A further embodiment of the invention is a habitat wherein said divider is disposed substantially aligned with said upper opening.

A further embodiment of the invention is a habitat wherein said divider creates at least two compartments within said habitat.

A further embodiment of the invention is a habitat wherein a first compartment is filled with soil, allowing plant life to grow.

A further embodiment of the invention is a habitat wherein a second compartment is filled with water.

A further embodiment of the invention is a habitat wherein said divider is further comprised of an opening disposed along the upper edge of said divider.

A further embodiment of the invention is a habitat wherein said habitat is mounted via a pole attached to a bottom surface.

A further embodiment of the invention is a habitat wherein said habitat is mounted via a pole attached a back surface.

A further embodiment of the invention is a habitat is a mosquito habitat comprised of an outer shell, at least one divider creating at least a first compartment and at least a second compartment, and at least one opening disposed within said outer shell.

A further embodiment of the invention is a habitat wherein said first compartment and said second compartment may be filled with water.

A further embodiment of the invention is a habitat wherein said first compartment and said second compartment may be filled with soil.

A further embodiment of the invention is a habitat wherein said divider has disposed therein an opening allowing water to flow between said at least one first compartment and said at least one second compartment.

### BRIEF DESCRIPTION OF THE DRAWINGS

FIG. 1 is a rendering of a perspective view from the front right of an embodiment of the habitat of the present invention.

FIG. 2 is a cross sectional side view of an embodiment of the habitat of the present invention.

FIGS. 3A and 3B are perspective views from the right front of an embodiment of the habitat of the invention and showing how the invention may be mounted.

FIG. 4 is a rendering of the rear of an embodiment of the invention.

FIGS. 5A through 5C are renderings of alternative embodiments of the habitat of the present invention.

FIG. 6 is a cross sectional side view of an alternative embodiment of the habitat of the present invention.

FIG. 7 is a cross sectional side view of an alternate embodiment of the habitat of the present invention.

### DETAILED DESCRIPTION OF THE DRAWINGS

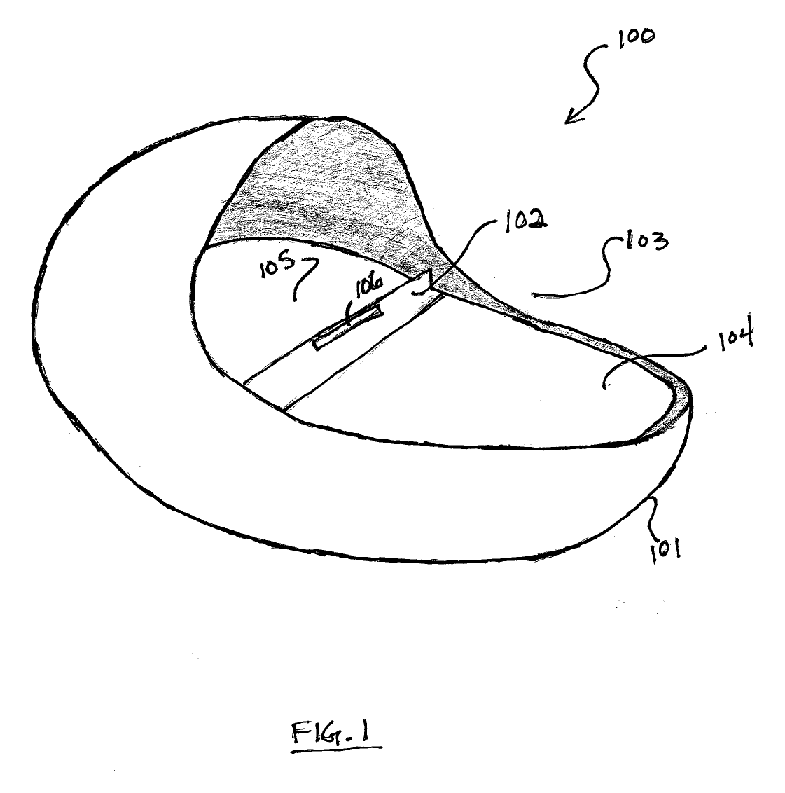

FIG. 1 is a perspective rendering of an embodiment of the habitat 100 of the invention viewed from the right front. An embodiment of the habitat 100 of the invention is composed of an outer shell 101 that may be composed of plastic, metal, rubber, or any other durable material that can withstand constant exposure to the outdoors and natural elements. As rendered, the habitat 100 is sufficiently egg-shaped, but one of ordinary skill in the art will understand that the habitat 100 may be of any shape and size, which are only limited by the parameters described herein such that it may function as designed. The shell 101 is open at the front 103 so that the toxorhynchite mosquitoes may enter and exit the habitat 100. A divider 102 is placed just outside the main opening of the habitat 100 such that rises to the height of the main opening 103. The divider 102, which may be attached and secured to the inside of the habitat 100 at the sides or bottom or both by any means that will provide stability and support and maintain integrity, creates a forward, open compartment 104, which holds dirt and mud and a rear, enclosed compartment 105 to contain water. Both environments are necessary components of the preferred natural habitat of the toxorhynchite mosquito. The divider 102 includes an opening 106 along its top edge so that water may flow from the rear compartment 105 to the front compartment 104 to prevent naturally collecting, excess water to overflow from the open front section and/or from washing the needed dirt and mud out of the front compartment 104. The water flowing into the front compartment 104 will also allow for plant and vegetation growth in the front compartment 104 in order to create a more natural habitat for the toxorhynchite mosquito. It will be understood by one of ordinary skill in the art that once initially set up and, the habitat 100 will require little to additional maintenance.

FIG. 2 is a cross sectional view of the habitat 100. The divider 102 is more clearly shown, as well as the front 104 and rear 105 compartments. The front compartment 104, as described, contains soil and small plants 201, which are beneficial to the toxorhynchite mosquito. The rear compartment 105 contains water 202, which provides breeding areas for the toxorhynchite mosquito and feeds the small plants 201 in the front compartment 104.

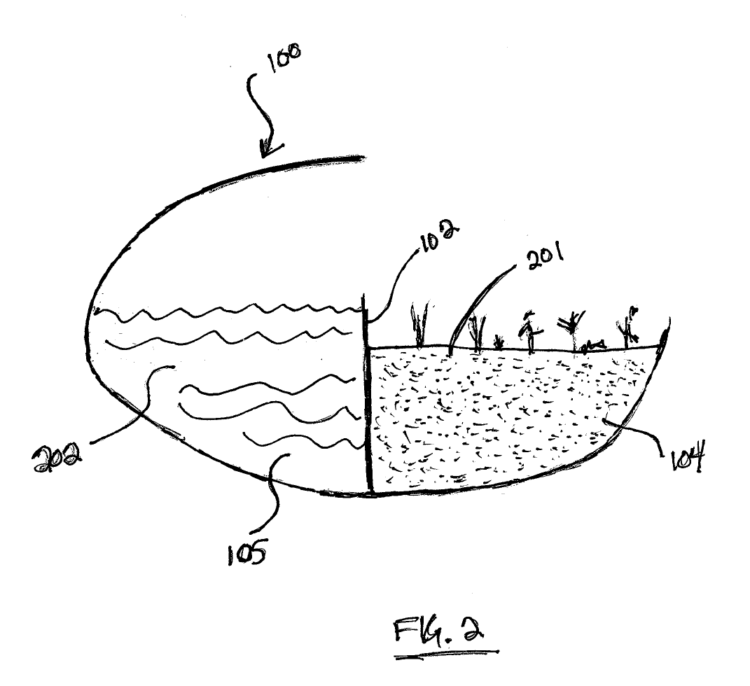

FIGS. 3A and 3B show how the habitat 100 may be mounted or placed. FIG. 3A shows the habitat mounted to a post or pole 301 on its bottom surface. Such a pole 301 may be placed the ground, cemented in the ground, or may be attached to a stand 302 such that it may be portable. FIG. 3B shows the habitat 100 mounted on a pole 303 at the back of its shell. Such a pole may then be mounted on a wall or the side of a dwelling or other building of human habitation. It will be understood by one of ordinary skill in the art that although the figures, depictions, and disclosures herein discuss applications and variations of a single habitat, any number of habitats of any embodiment of the invention may be clustered together for maximum effect.

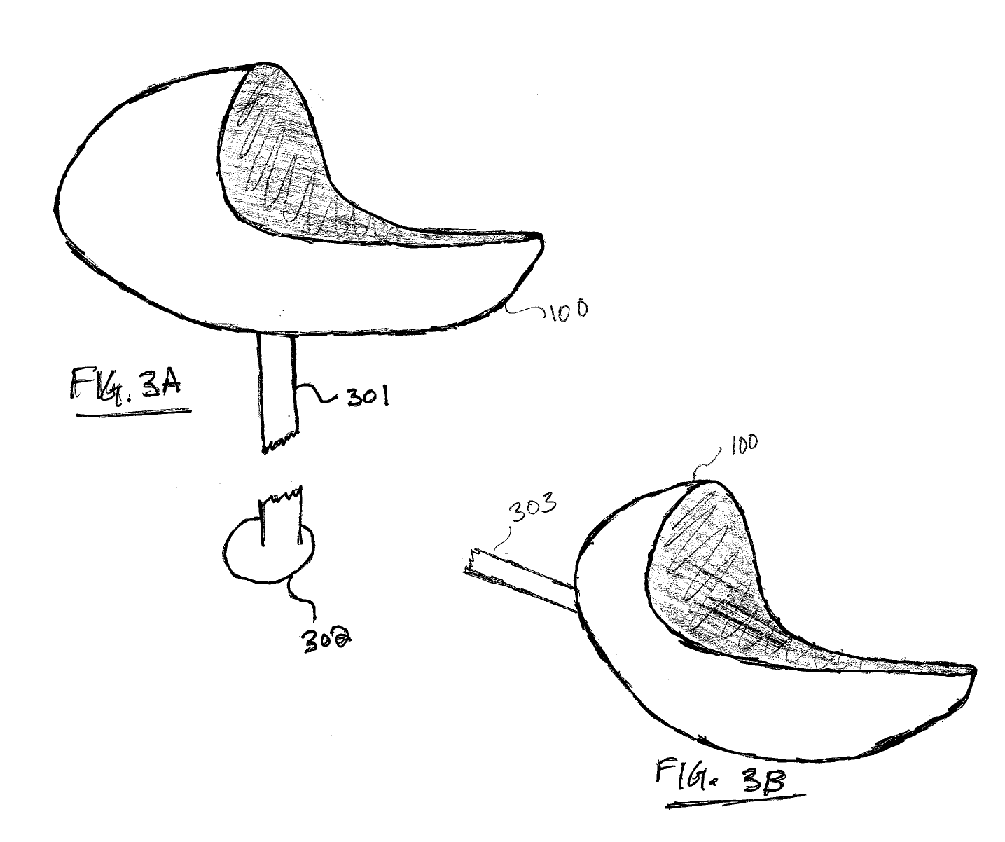

FIG. 4 shows the rear of the habitat 100. Disposed on the back of the habitat is at least one opening to allow excess water may flow out of the back of the habitat 100. Although water flowing into the front compartment 104 is desired to support plant growth, too much would wash away the soil of the habitat. Therefore, the opening in the rear is positioned in such a location and at a level such that the water will be maintained in the rear compartment 105 below the level of the height of the divider 102.

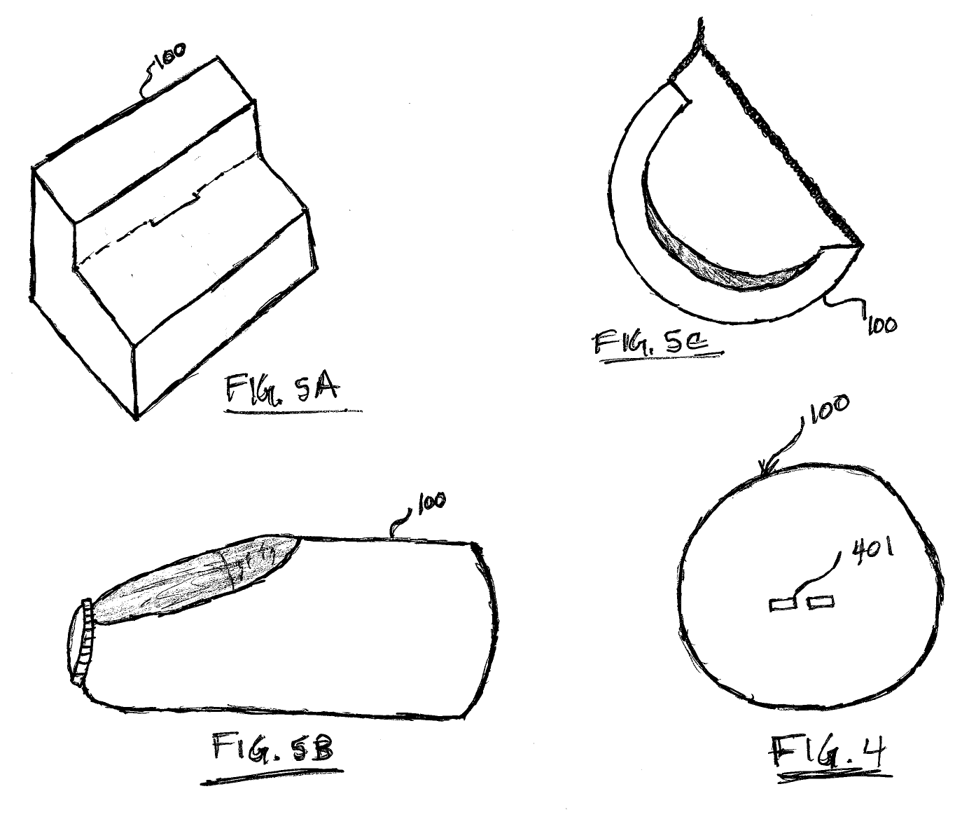

FIGS. 5A to 5C are alternate embodiments of the habitat 100 constructed from other materials and objects. FIG. 5A shows a habitat constructed of a substantially rectangular object, such as an old computer monitor, packing crate, television monitor, etc. . . . One of ordinary skill in the art will understand that any hollow, substantially rectangular shaped box of durable materials that will withstand outdoors and natural elements will suffice for construction. Such a shell 101 may be composed of a material that needs to be reused or recycled. FIG. 5B shows a habitat 100 constructed from a household cleaner bottle, such as bleach, ammonia, or any other recyclable or reusable material. FIG. 5C shows a habitat 100 constructed from a used tire that may be hung by chains from a tree or tower.

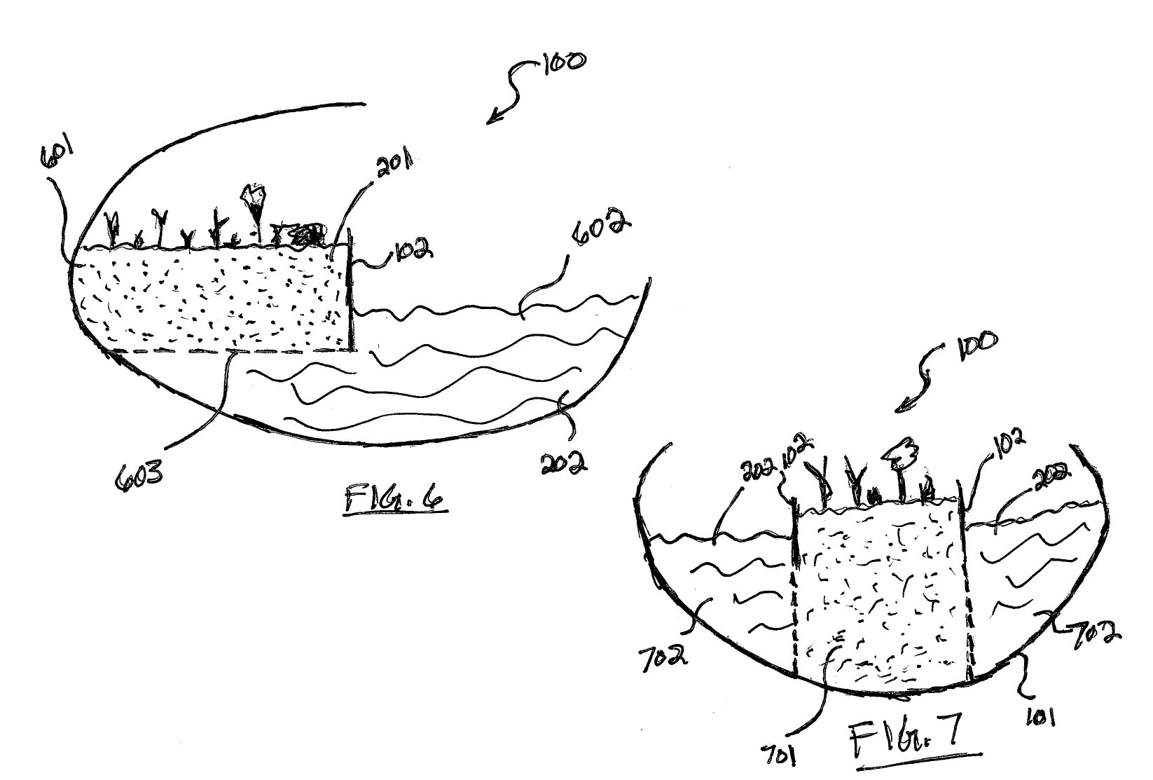

FIG. 6 shows an alternative exemplary embodiment of the habitat 100 in which the soil 201 containing compartment 601 is located at one end of and slightly elevated from the water 202 containing compartment 602. The divider 102 may be substantially attached to the sides of the habitat 100 by means to maintain the integrity and stability of the compartment 601. Attached between the bottom of the divider 102 and the shell 101 of the habitat 100 is a platform 603 composed of a permeable material or with openings small enough such that the soil 201 will remain in the compartment but allow water 202 to pass through. Such a configuration allows any vegetation within the soil 201 compartment 601 to grow and the soil to soak up the water 202 from the water containing compartment 602.

FIG. 7 shows and alternative exemplary embodiment of the habitat 100 in which the soil 201 containing compartment 701 is situated between two water 202 containing compartments 702. The habitat 100 in this embodiment is substantially bowl-shaped. This embodiment has two dividers 102, which may be attached to the bottom and sides of the shell by any means, which maintains stability and the integrity of the compartment 701. The dividers 102 may be of a permeable material or with openings small enough such that the soil 201 will remain in the compartment but allow water 202 to pass through.

As is shown by the above Figures, there are a wide variety of shapes, sizes, and materials from which an embodiment of the habitat of the invention may be constructed. One of ordinary skill in the art will understand that the above figures are for exemplary purposes only and not for purposes of limitation, including use of the habitat. Any and all shapes or materials that may be used for any purpose but containing the structure described herein are hereby disclosed.

I claim:

1. A habitat for mosquitoes and other insects comprising:
an outer shell;
at least one divider disposed such within the interior of the outer shell; and
at least one upper opening in the upper half of said outer shell.

2. The habitat of claim 1 wherein said outer shell is comprised of molded plastic.

3. The habitat of claim 1 wherein said outer shell is comprised of a tire.

4. The habitat of claim 1 wherein said outer shell is comprised of a monitor device.

5. The habitat of claim 1 wherein said outer shell is further comprised of at least one opening in the rear of said outer shell.

6. The habitat of claim 1 wherein said divider is disposed substantially aligned with said upper opening.

7. The habitat of claim 1 wherein said divider creates at least two compartments within said habitat.

8. The habitat of claim 7 wherein a first compartment is filled with soil, allowing plant life to grow.

9. The habitat of claim 7 wherein a second compartment is filled with water.

10. The habitat of claim 1 wherein said divider is further comprised of an opening disposed along the upper edge of said divider.

11. The habitat of claim 1 wherein said habitat is mounted via a pole attached to a bottom surface.

12. The habitat of claim 1 wherein said habitat is mounted via a pole attached a back surface.

13. A mosquito habitat comprised of an outer shell, at least one divider creating at least a first compartment and at least a second compartment, and at least one opening disposed within said outer shell.

14. The habitat of claim 14 wherein said first compartment and said second compartment may be filled with water.

15. The habitat of claim 14 wherein said first compartment and said second compartment may be filled with soil.

16. The habitat of claim 14 wherein said divider has disposed therein an opening allowing water to flow between said at least one first compartment and said at least one second compartment.
